(19) United States
(12) Patent Application Publication
(10) Pub. No.: US 2008/0049583 A1
(43) Pub. Date: Feb. 28, 2008

(54) OPTICAL PICKUP DEVICE

(76) Inventors: Tatsuro IDE, Kawasaki (JP); Kotaro Oishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/673,676

(22) Filed: Feb. 12, 2007

(30) Foreign Application Priority Data
Aug. 25, 2006 (JP) 2006-229631

(51) Int. Cl. G11B 7/00

(52) U.S. Cl. 369/112.16

(57) ABSTRACT

An optical pickup device for resolving problems with deterioration in the RF signal due to crosstalk from the preformatted structures in optical disks which provide address information, especially the Land Pre-Pit signal in optical disks such as DVD-R and DVD-RW disks with a LPP (Land Pre-Pit) structure. When the ratio of electric amplitude (Etan/Erad) of the incident light onto the disk, where Etan and Erad shows the electric amplitude of the foregoing light in the tangential and radial direction of the disk, is set to γ then the optical pickup device is set so that 0.7<γ (electrical amplitude ratio)<0.8.

### CLAIM OF PRIORITY

The present application claims priority from Japanese application JP 2006-229631 filed on Aug. 25, 2006, the content of which is hereby incorporated by reference into this application.

### FIELD OF THE INVENTION

The present invention relates to an optical pickup device for writing or reading information by focusing light onto an optical disk, and relates to an optical pickup device for lowering deterioration in the readout signal occurring due to crosstalk from preformatted structure (especially Land Pre-Pit (LPP)) in recording mediums where address information and control signals for disk rotation (hereafter pre-information) were previously recorded which are necessary when recording information, and particularly in high density optical information recording medium typified by DVD disks (writable media) preformed with land pre-pits (LPP) for detecting address information in the land regions of disks such as write-once DVD-R and rewritable DVD-RW disks.

### BACKGROUND OF THE INVENTION

Optical disks are currently used as mediums for recording high-capacity information. Optical disks are utilized for recording digital data such as images, music. Recordable DVDs (digital versatile discs) include DVD-RAM, DVD-RW, DVD+RW, DVD-R, and DVD+R. The demand for writable DVD has rapidly increased in recent years. The Blu-ray disc and HD DVD, the next generation optical disc with higher capacity are produced as commercial products.

Concentric or spiral tracks which consist of groove 101 and land 102 are formed on the recording surface of the write optical disk for guiding the laser beam as shown in FIG. 1. Among recordable DVD, as for DVD-RAM, the information is recorded on both the grooves and the lands. On the other hand, the information is recorded only on the grooves for other recordable DVDs. The groove 101 wobbles slightly towards the radius of the disk within a specified period. The optical disk drive detects the frequency of the wobbling (wobble signal) on the track, extracts the reference clock for controlling rotation of the optical disk based on this wobble signal, and controls the rotation of a spindle motor for rotating the optical disk based on this extracted reference clock.

A land pre-pit: (LPP) 103 is preformed as isolated pits formed between the adjacent grooves 101 on the DVD-R and the DVD-RW. When recording (or writing) information, the optical disk drive acquires optical disk address information by detecting the LPP signal based on the land pre-pit 103 (LPP), and accurately controls the position based on this address information.

The laid-open patent JP-A No. 227642/2004 disclosed a method to allow satisfactory reading of the LPP signal by utilizing beam shaping and a focusing lens which can be controlled along the optical axis. Also reported were improvements in cross talk and the ability to limit changes in the spot diameter along the radius. The laid-open patent JP-A No. 346337/2003 disclosed that power or pulse width of the laser was changed when the mark whose amplitude of readout signal was smaller than maximum amplitude of eye pattern was recorded to the side of the LPP.

### SUMMARY OF THE INVENTION

The optical disk drive detects the LPP signal as a tracking error signal using the conventional push-pull method. FIG. 2 shows the LPP signal detection state. The photo detectors receive light reflected from the optical disk as light divided into at least two portions at division lines optically parallel to the tangential direction of the groove. The differential in the perpendicular direction among output signals from these photo detectors in each area is obtained, and the sum of the sine wave signals accompanying the wobble of groove 101 and the rectangular wave signal generated at the land pit 103 position form the push-pull signal 201. In the land pit section as shown in FIG. 2, the push-pull signal 201 protrudes in a pulse shape. The LPP signal 202 is generally detected by level detection of the push-pull signal. In other words, only those sections showing a voltage larger than a fixed voltage (slice signal) are extracted as the LPP component. The RF signal is detected from the total sum of the signals detected from all light sensors. The reference numeral 203 in FIG. 2 indicates the light spot. In the DVD drive, the diameter of this spot (1/e² spot diameter) is approximately 1.0 micrometer versus a track pitch of 0.74 micrometers.

When writing data on recordable optical disks, the pre-information formed in advance for acquiring address information and in particular the land pre-pit (LPP) on DVD-R, DVD-RW disks are basically detected as tracking error signals as described above. The shape of the LPP is designed not to render effects during read. However, the optical spot diameter irradiated onto the recording surface of an optical disk such as a DVD-R during reading or writing of data, is larger than the groove width, so that a portion of the spot light strikes the adjacent land area, and in actual operation this LPP signal leaks as noise (cross talk) into the RF signal. If the effect of this crosstalk from the LPP signal into the RF signal is large, the problem occurs that reading and writing of information is unsatisfactory. Marks for example from 3T to 14T (T is the channel clock period.) long are formed on a DVD, however the smaller the mark length, the smaller the read signal modulation becomes so that the effect from LPP signal cross talk becomes large. The RF signal modulation from the 3T mark on a DVD-R disk is approximately 20 to 30 percent so that the LPP signal cross talk into the RF signal is at most 10 percent. When one takes product variations into account, this cross talk should preferably be suppressed to within 5 percent in order to guarantee a more satisfactory read/write signal.

Write-type DVD pickups typically do not perform beam shaping in recent years in order to reduce the number optical components and lower costs. However, cross talk from the LPP signal cross talk into the RF signal should preferably be lowered even when there is no beam shaping function in write-type DVD pickups. Cross talk from the LPP signal into the RF signal also occurs even on disks where no data has yet been recorded (written) and cross talk should be reduced regardless of whether there are recording pits.

This invention has the object of providing a method for reducing cross talk in optical pickup devices due to the pre-pit information signal (LPP signal) into the RF signal when recording or writing onto an optical disk containing a land pre-pit structure within the recording surface on recordable mediums especially DVD-R, DVD-RW disks recorded in advance with pre-information such as rotation control signals or address information required for writing information.

In the optical pickup device of this invention for reading or writing data on an optical disk containing circumferentially positioned pre-information (land pre-pits) including address information in land areas between recording tracks on recording mediums especially DVD-R, DVD-RW disks recorded with pre-information such as rotation control signals or address information required for writing information, the polarized light status of light incident onto the recording surface of the optical disk from a light source is defined as shown in FIG. 3. Namely, the ratio of electric amplitude γ is set to satisfy the following formula (1) when the electrical amplitudes along the disk radius (rad.) and along the disk circumference (tan.) are respectively Erad and Etan, and the electric amplitude ratio along the radius and circumference are respectively defined as γ (=Etan/Erad).

0.7<γ<0.8 (1)

The cross talk from the LPP signal into the RF signal can largely be prevented by using the above structure, and a stabilized read/write signal obtained. The γ moreover is preferably suppressed to approximately 0.8 in order to successfully limit the drop in RF signal level via polarized beam splitters compared to when inputting conventional circularly polarized light, and to suppress LPP signal cross talk from into the RF signal.

The ratio of electric amplitude γ is preferably set to satisfy the following formula (2) in order to limit LPP signal cross talk into RF signal within 5 percent.

0.5<γ<0.95 (2)

These methods can successfully lower the effect of LPP signal cross talk into RF signal when reading or writing on DVD-R or DVD-RW disks, and allow stable read and write of the signal.

The above described conditions (1) and (2) for polarized light on the disk surface, define the ratio of electric amplitude along the radius and circumference of the disk, and the polarized light on the disk surface may also for example be linearly polarized light.

The optical pickup device of this invention is capable of reading and writing a stabilized signal on the disk in order to reduce LPP signal crosstalk into the RF signal during reading or writing of signals onto disks containing isolated pits (land pre-pits) for detecting address information in land areas within the recording surface on DVD-R and DVD-RW disks, etc.

### BRIEF DESCRIPTION OF THE DRAWINGS

FIG. 1 is a drawing of the recordable DVD disk;

FIG. 2 is a drawing for describing the push-pull signal and the LPP signal;

FIG. 3 is a drawing showing the polarization state of the incident light on the surface of the optical disk;

FIG. 4 is a concept drawing showing the structure of the optical pickup device;

FIG. 5 is a drawing showing the function of the quarter-wave plate;

FIG. 6A is a drawing for defining LPP signal cross talk into the RF signal on an enlarged view of a portion of the optical disk recording surface;

FIG. 6B is a drawing showing the RF signal when the optical spot gets across the LPP during recording;

FIG. 7 is a graph showing the interrelation between the polarization state on the optical disk surface (electric amplitude ratio τ) and the LPP signal cross talk into the RF signal, and the reflection level of the mirror section;

FIG. 8 is a drawing showing the structure of the optical pickup device.

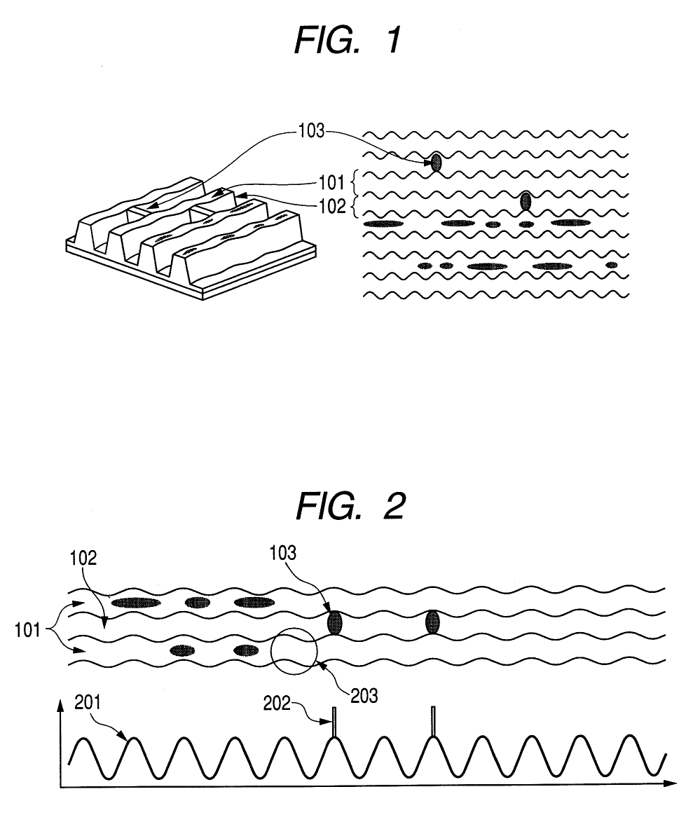

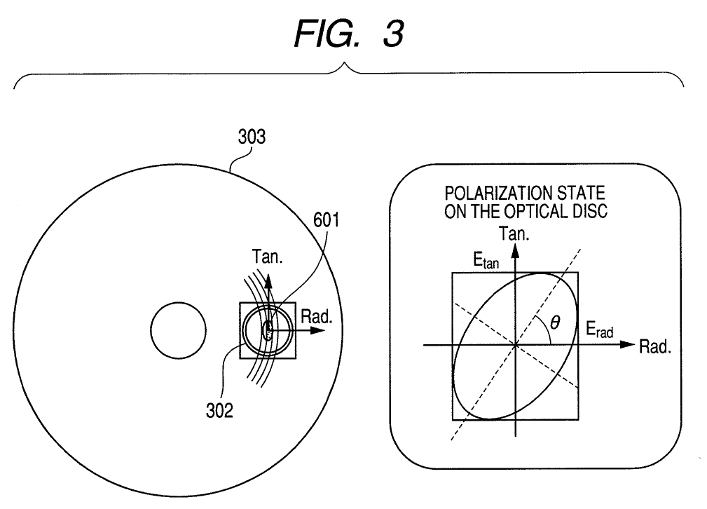

### DETAILED DESCRIPTION OF THE EMBODIMENTS

The embodiments of this invention as an optical pickup device for reading or writing DVD disks where land pre-pits (LPP) are formed, is described next while referring to the drawings.

### First Embodiment

The first embodiment relates to an optical pickup device using a polarized beam splitter as the beam splitter.

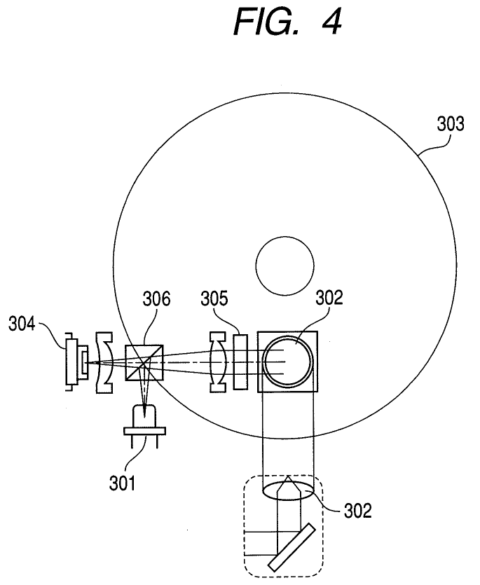

FIG. 4 is a drawing showing an example of a structure of the optical pickup device for reading and writing on optical disks such as a DVD-R. The drawing enclosed by the dotted line on the lower side of FIG. 4 shows a side view of the upper dotted line section (mirror and objective lens). An objective lens 302 in the optical pickup device focuses the light from the semiconductor laser 301, and irradiates the light through the transparent substrate of the optical disk 303 and onto the information recording surface. Physical deformation and chemical deformations occurring in the recording layer due to the heat effect from the laser beam are utilized in the writing (recording) of information. During reading of information, a photodetector 304 detects the reflected light from the optical disk 303 split into multiple light rays, to read out the information according to the strength or weakness of the reflected light intensity. The photodetector 304 at this time detects the intensity of the reflected light from the optical disk 303 for correctly focusing the light from the semiconductor laser 301 onto the track within the information recording surface of the optical disk 303, as an electrical signal. A readout (RF: Radio Frequency signal) signal and a servo signal (such as focus error signals and tracking error signals) are then output from that electrical signal, to control the position of the objective lens 302 by using that servo signal.

Writing onto the optical disk requires a high amount of energy so polarized light is utilized to boost the light efficiency in typical optical pickups. The semiconductor laser 301 emits linearly polarized light as diffused light. This light is reflected via a polarized beam splitter (PBS) 306 and input to a quarter-wave plate 305. Light input to the quarter-wave plate is converted from linearly polarized light (P polarized light) to circularly polarized light. The objective lens 302 then focuses the light onto the optical disk 303. The light reflected from the optical disk 303 is supplied again to the quarter-wave plate 305. The light input to the quarter-wave plate again becomes linearly polarized light, however the direction of that polarized light (S polarized light) is perpendicular to the forward path of that polarized light. The light converted by the quarter-wave plate 305 to S polarized light, transmits through the polarized beam splitter 306 and is detected by the photodetector 304. By combining the polarized beam splitter and quarter-wave plate in this way, the polarizing direction versus the beam splitter can be tilted 90 degrees on the forward and return paths to boost the reflection efficiency on the forward path and the transmittance on the return path.

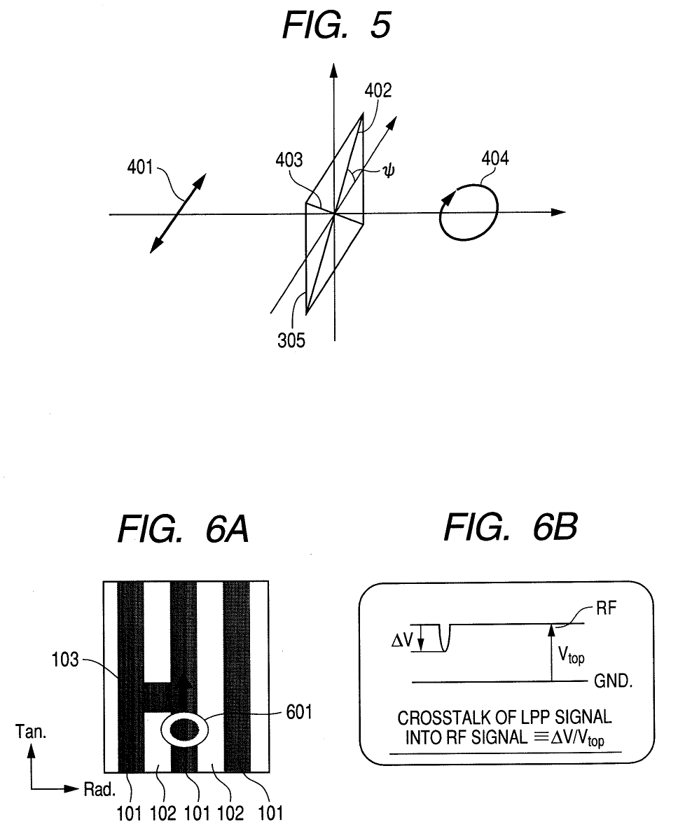

The quarter-wave plate is described next. Phase plates such as the quarter-wave plate are made from birefringent crystal such as quartz. The phase plates are of two intersecting axes (an accelerating axis 402 whose phase is leading and a decelerating axis 403 whose phase is lagging) as shown in FIG. 5. The state of the polarized light being input changes because a phase differential occurs in the electrical field vector versus each axis. There is a phase differential of π/2 (¼ wavelength) between the accelerating axis and decelerating axis of the quarter-wave plate. When the angle formed by direction of the directly polarized light 401 input to the quarter-wave plate versus the accelerating axis of the quarter-wave plate is set as ψ, the polarized state of the transmittance light 404 as E_{f} and Eₛ for the respective accelerating axis and decelerating axis direction components then becomes the state as shown below.

$$\begin{matrix}\text{[Formula 1]} & \\ [ \begin{matrix}{E}_{f} \\ {E}_{s}\end{matrix} ] = [ \begin{matrix}1 & 0 \\ 0 & {e}^{- i \frac{π}{2}}\end{matrix} ] [ \begin{matrix}cos ψ \\ sin ψ\end{matrix} ] = [ \begin{matrix}cos ψ \\ - i sin ψ\end{matrix} ] & ( 3 )\end{matrix}$$

Here, elliptically-polarized light is typically used since the amplitude ratio for the accelerating axis and decelerating axis direction components is set as tan ψ, and the phase differential is ψ/2. The transmittance light becomes circularly polarized light in particular when the ψ=±45 degrees.

In the optical pickup device shown in FIG. 4, the polarized beam splitter 306 reflects light (linearly polarized light: P polarized light) emitted from the semiconductor laser 301, converting it via the quarter-wave plate 305 into circularly polarized light. In the optical pickup device of the related art, the accelerating axis of the quarter-wave plate is tilted to a ψ=45° versus the polarized direction of the input light in order to convert the linearly polarized light to circularly polarized light. When the angle formed by the direction of the linearly polarized light input to the quarter-wave plate and the accelerating axis of the quarter-wave plate is set to ψ, the polarized state of the transmittance light as Ef and Es for the respective accelerating axis and decelerating axis components is then expressed by the state shown in formula (3). The amplitude ratio for the accelerating axis and decelerating axis components is set as tan ψ, so that in this embodiment, the quarter-wave plate is rotated in a direction within the surface so that the polarized state of the light input within the surface satisfies the formula (1). If the quarter-wave plate for example is tilted to become tan−1 (0.7)<ψ<tan−1 (0.8) when the polarized direction of light emitted from the semiconductor laser 301 is parallel to the disk radius, then the elliptically polarized light satisfies the formula (1) after having transmitted through the quarter-wave plate. The polarized state of the input light changes somewhat during actual operation due to effects from variations in the polarized state of the light emitted from the semiconductor laser, variations in the accelerating axis of the quarter-wave plate and also due to effects from other optical components. There are also effects from disk birefringence and therefore the rotation angle of the quarter-wave plate is preferably adjusted while monitoring cross talk from the LPP signal into the RF signal, during assembly of the optical pickup so that the cross talk will be small.

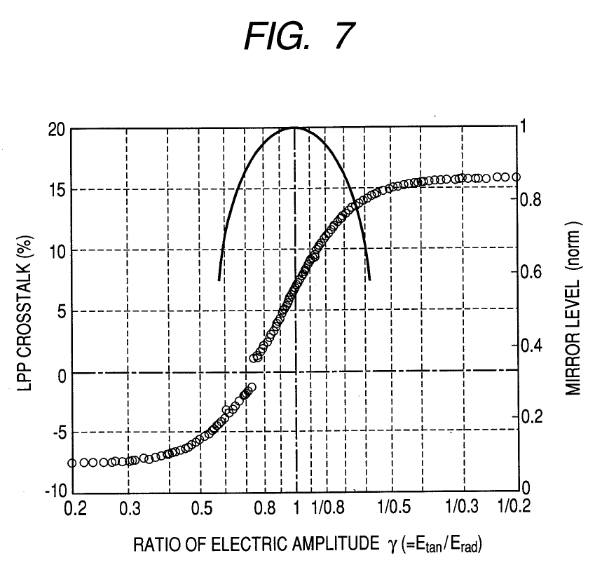

The cross talk from the LPP signal into the RF signal is defined as shown in FIG. 6. FIG. 6A is an enlarged view of a portion of the optical disk recording surface with land pre-pits 103 formed on the land area 102. The light spot 601 scans the grooves 101 during recording (writing) of information. FIG. 6B is a drawing showing the RF signal at that time. Usually, when the light spot of the circularly polarized light input by the optical pickup travels across the LPP as shown in FIG. 6, the LPP signal leaks as cross talk into the RF signal, causing the amplitude of the RF signal to diminish. When the reduction in RF signal amplitude versus the RF signal amplitude Vtop is expressed as ΔV, then the cross talk is defined as:

Cross talk=ΔV/Vtop (4)

In this definition, the cross talk is a negative value when the RF signal amplitude increases when the light spot travels across the land pre-pit. The absolute value for cross talk is preferably small in order to obtain stable read/write signals. FIG. 7 is a graph showing the interrelation between the polarization state on the disk surface of a DVD-R disk containing land pre-pits as shown in FIG. 6 and the LPP signal cross talk into the RF signal, and reflection level of a portion of the mirror (same as RF signal level). In this structure, one can see that large cross talk occurs in the negative direction when a long elliptically polarized light is input along the disk circumference (tan.) at a disk polarization state as shown in FIG. 3, and conversely that a large cross talk occurs in the positive direction when a long elliptically polarized light is input along the disk radius (rad.). The LPP signal cross talk into the RF signal can be sufficiently suppressed when the polarized state is set to:

0.7<γ<0.8 (5)

The RF signal here is the correct amplitude value without being affected by the LPP signal. The RF level of the PBS optical system will however decrease somewhat compared to the related art when circularly polarized light is input (γ=1) so γ of approximately 0.8 is preferable.

The polarization state on the disk surface is set as shown in the next formula to limit the LPP signal to within 5 percent.

0.5<γ<0.95 (5)

By adjusting the tilt within the quarter-wave plate surface and setting the polarization state of light input the optical disk surface to satisfy the formula (5) or formula (6) in this way, the LPP signal cross talk into the read RF signal can be reduced and a satisfactory signal read and write achieved.

In this embodiment, the quarter-wave plate was rotated to change the polarization state on the surface of the optical disk. However, a phase plate or a polarizing element separate from the quarter-wave plate may be installed between the light source and objective lens. This phase plate and polarizing element are set so that the polarization state on the optical disk surface satisfies the above formula (5) or formula (6) during assembly of the optical pickup.

### Second Embodiment

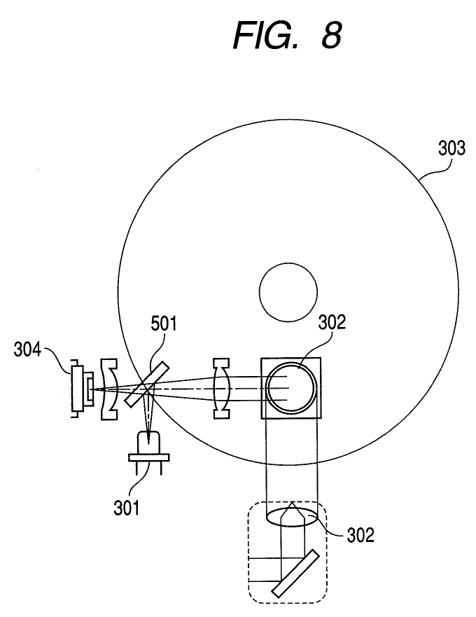

The second embodiment relates to an optical pickup device utilizing a half mirror in the beam splitter. The write pickup utilizes a polarized beam splitter (PBS) as the beam splitter as described above. However the polarized beam splitter is a comparatively expensive optical component and its reflection rate and transmittance rate along the return path in the optical system fluctuate due to effects from disk birefringence. Therefore, as shown in FIG. 8, a half mirror 501 not dependent on the incident light polarizing direction might sometimes be used instead of the polarizing beam splitter when a disk such as a CD has large birefringence. The drawing enclosed by the dotted line on the lower side of FIG. 8 shows a side view of the upper dotted line section (startup mirror and objective lens).

In the optical pickup device shown in FIG. 8, after half-mirror 501 reflects the light (linearly polarized light: P polarized light) emitted from the semiconductor laser 301, the objective lens focuses the light onto the recording surface of the optical disk. In this embodiment, the optical pickup device rotates the optical axis of the semiconductor laser, so that the polarization state of the light incident onto the disk surface satisfies the following formula.

0.7<γ<0.8 (7)

The cross talk into the RF signal from the LPP signal can in this way be adequately limited. The polarized state of the input light changes somewhat during actual operation the same as in the first embodiment, due to effects from variations in the polarized state of the light emitted from the semiconductor laser, and from variations in the optical elements. There are also effects from disk birefringence so that preferably the semiconductor laserrotation angle is adjusted versus the optical axis while monitoring leakage from the LPP signal into the RF signal during assembly of the optical pickup so that cross talk will be small.

The polarization state on the disk is set to satisfy the following formula in order to suppress LPP signal cross talk within 5 percent.

0.5<γ<0.95 (8)

The optical pickup device in this way rotates the quarter-wave plate so that the polarization state of light incident input onto the surface of the optical disk satisfies the formula (7) or formula (8) to reduce LPP signal cross talk leakage into the RF signal and allow a stable read and write signal.

This invention is applicable to optical pickup devices for reading and writing on optical disks containing land pre-pit structures within the recording surface on optical disks and particularly DVD-R and DVD-RW disks, etc.

What is claimed is:

1. An optical pickup device for reading and writing information on an optical disk formed at intervals with land pre-pits (LPP) holding address information on land areas between recording tracks; the optical pickup device including a light source; an objective lens for focusing light emitted from the light source onto an optical disk; an optical beam splitter branching device for separating the light emitted from the light source and light reflected from the disk; and a light sensor photo detector for receiving the light reflected from the optical disk separated by the optical branching device,
wherein the polarized state of light incident input onto the optical disk surface is set to satisfy
0.7<γ(electrical amplitude ratio)<0.8
where the ratio Etan/Erad for electric amplitude Erad along the disk radius to electric amplitude Etan along the disk circumference is set as (.

2. The optical pickup device according to claim 1, wherein a quarter-wave plate is installed between the optical beam splitter branching device and the objective lens, and the tilt or rotation within the quarter-wave plate surface is set to satisfy 0.7<(<0.8.

3. The optical pickup device according to claim 1, wherein the rotation angle versus the optical axis of the light source is set to satisfy 0.7<(<0.8.

4. An optical pickup device for reading and writing information on an optical disk prerecorded with pre-information including rotation control signals and address information needed when recording information, the optical pickup device including a light source; an objective lens for focusing light emitted from the light source onto an optical disk; an optical beam splitter branching device for separating the light emitted from the light source and light reflected from the disk; and a photo detector light sensor for receiving the light reflected from the optical disk separated by the optical beam splitter branching device,
wherein the polarized state of light incident input onto the optical disk surface is set to satisfy
0.7<((electrical amplitude ratio)<0.8
where the ratio Etan/Erad for electric amplitude Erad along the disk radius to electric amplitude Etan along the disk circumference is set as (.

5. The optical pick device according to claim 4, wherein a quarter-wave plate is installed between the optical beam splitter branching device and the objective lens, and the tilt or rotation within the quarter-wave plate surface is set to satisfy 0.7<(<0.8.

6. The optical pick device according to claim 4, wherein the rotation angle versus the optical axis of the light source is set to satisfy 0.7<γ<0.8.

7. An optical pickup device for reading and writing information on an optical disk formed at intervals with land pre-pits (LPP) holding address information on land areas between recording tracks, the optical pickup device including a light source; an objective lens for focusing light emitted from the light source onto an optical disk; an optical beam splitter for separating the light emitted from the light source and light reflected from the disk; and a photo detector for receiving the light reflected from the optical disk separated by the optical beam splitter branching device,
wherein the polarized state of light incident onto the optical disk surface is set to satisfy
0.5<γ(electrical amplitude ratio)<0.95
where the ratio Etan/Erad for electric amplitude Erad along the disk radius to electric amplitude Etan along the disk circumference is set as γ.

8. The optical pick device according to claim 7, wherein a quarter-wave plate is installed between the optical beam splitter and the objective lens, and the tilt or rotation within the quarter-wave plate surface is set to satisfy 0.5<γ<0.95.

9. The optical pick device according to claim 7, wherein the rotation angle versus the optical axis of the light source is set to satisfy 0.5<γ<0.95.
